(19) United States
(12) Patent Application Publication
(10) Pub. No.: US 2011/0091613 A1
(43) Pub. Date: Apr. 21, 2011

(54) ORGANIC COMESTIBLE FORMULATION

(76) Inventors: Julie Glick, Patterson, NY (US); Thomas W. Wolff, Brewster, NY (US)

(21) Appl. No.: 12/438,399

(22) PCT Filed: Aug. 21, 2007
(86) PCT No.: PCT/US07/18452

§ 371 Date: Jan. 10, 2011

Related U.S. Application Data
(60) Provisional application No. 60/839,360, filed on Aug. 21, 2006.

(51) Int. Cl. A23G 1/48; A23G 9/42; B65D 85/60

(52) U.S. Cl. 426/108; 426/631; 426/572; 426/565

(57) ABSTRACT

Formulations of chocolate-based snack food and desserts, such as mousse, truffles and ice cream, comprising raw organic ingredients are provided. The method for making the snack food and dessert products of the present invention are also provided.

### FIELD OF THE INVENTION

The present invention relates generally to the food industry field. The invention specifically relates to formulations of organic food products and methods of Making thereof. Particularly, the present invention relates to the formulations of, and methods for producing, chocolate-based snack foods or desserts, such as chocolate mousse and truffles by using raw organic natural ingredients so that live enzymes in the ingredients are biologically active or intact in a natural state.

### BACKGROUND OF THE INVENTION

Traditional snack foods and/or desserts, such as chocolate mousse and truffles contain certain ingredients that are now considered unhealthy. For example, many dairy products contain fat and so called “bad cholesterols”, which have proven to cause many diseases including cardiovascular diseases. Studies also show that sugar intake may be related to the development of coronary artery disease, diabetes mellitus, obesity, and dental caries. Traditional or industrial produce is grown with, and therefore may be contaminated by, chemicals that are toxic and/or harmful to human body. For example, residue of multiple pesticides, herbicides, and/or synthetic fertilizers have been found in conventional produce including cocoa plants used for producing chocolate, one of the most favorite flavors used in the food industry. Cows producing dairy products may be fed with food that is contaminated by pesticides and/or other chemicals that are toxic and/or harmful the human body. Even though many of the unhealthy or contaminated ingredients used in traditional food processing may not be at a level that constitutes a violation of government regulations, more and more consumers are concerned about ingesting food with such ingredients. Thus, there is a need in the market to provide an alternative line of healthy and safe snack food products.

Organic or natural foods have become popular in recent years, and are produced without using toxic or harmful chemicals. Organic food products also contain more nutrients and taste better. Thus, organic foods provide a good source for making alternative, healthy and safe snack foods and desserts.

However, many nutrients, such as live enzymes in organic foods, which assist digestion and absorption of foods, are destroyed and/or become toxic substances if the organic foods are cooked or processed inappropriately (e.g., over processed). Inappropriate processing of organic foods may also cause the food products to lose flavor and/or consumer acceptable textures. For example, it is known that heating food at temperatures over 46-48° C. (or 115-118° F.), destroys the desired live enzymes in the food. There is therefore a need for new and/or alternative formulations of snack food/desserts having live enzymes as well as good flavor and consumer-acceptable textures or consistencies.

### SUMMARY OF THE INVENTION

The present invention recognizes that by mixing raw organic ingredients at a temperature not exceeding about 46° C. (or about 118° F.), creamy chocolate desserts and ice cream with live enzymes and rich flavors can be produced.

Accordingly, one aspect of the present invention is directed to a novel line of food formulations, particularly, chocolate-based snack food and dessert formulations, that comprise a mixture of raw organic nut butter, at least one raw organic sweetening agent, at least one raw organic flavor, and water. The present invention thus provides an advance in the food industry by providing healthier and more flavorful food products, wherein the desired biological molecules (e.g., enzymes) in the ingredients are preserved as biologically active or intact while undesired ingredients or chemicals, such as undesired carbohydrates (i.e., refined sugar) or pesticide residues, are not introduced or at least significantly minimized.

A particular aspect of the present invention is directed to a mousse product formulation comprising raw organic cacao nibs, preferably from the South American cacao bean, raw organic nut butter, raw organic dates, raw organic shredded coconut, raw organic dark agave nectar, raw organic sea salt and filtered water. In one aspect, coconut butter can be utilized in place of shredded coconut. For example, the present invention contemplates a formulation that yields about 64 oz of mousse, comprising about 12% to about 15% raw organic cacao nibs, preferably from the South American cacao bean, about 20% to about 25% raw organic total nut butter (e.g., cashew or almond nut butter or a combination thereof), about 15% to about 18% raw organic dates, 0% to about 2% raw organic shreded coconut or coconut butter, about 8% to about 10% raw organic dark agave nectar, about 0.1% to about 0.3% raw organic sea salt and about 40% to about 45% filtered water.

Another aspect of the present invention is directed to a method of making food products, preferably, chocolate-based snack food and dessert products, more preferably, ice cream, comprising mixing raw organic nut butter, at least one raw organic sweetening agent, at least one raw organic one flavor, water, and optionally at least one stabilizer. The mixture can be served fresh or frozen for storage for later use. According the present invention, the nut butter, sweetening agent and flavor in the mixture are raw organic natural products and the mixing process is conducted at a temperature not exceeding about 46 to about 48° C. or about 118° F., preferably, not exceeding about 46° C. or 118° F.

The food products contemplated by the present invention include, but are not limited to truffles, cookies with chocolate ganache filling, ice pop's, ice cream chocolate bars, energy bars, fudge pops, frosting, syrups and spreads, granola mixes, cake and pie fillings, and ganache. The present invention further contemplates a ready to mix or ready to serve organic snack food, dessert and/or ice cream package unit. By “package unit” is meant a discrete unit form, preferably, a unit form consistent with custom or trade standards in packaging a particular type of snack food, dessert or ice cream, e.g., 4 oz, 16 oz, 32 oz or 64 oz of ice cream package unit measured by total serving volume. According to the present invention, a package unit comprises all the ingredients of the formulation of the present invention for making a snack food, dessert or ice cream.

### DETAILED DESCRIPTION OF THE INVENTION

One embodiment of the present invention provides a snack food or dessert composition, particularly, an ice cream composition comprising an ingredient mixture of raw organic nut butter, at least one raw organic sweetening agent, at least one raw organic flavor, water, and optionally at least one organic stabilizer, wherein the live enzymes from the organic products are substantially intact or biologically active in the final product.

The snack food or dessert products contemplated by the present invention include, but are not limited to ice cream, cookies with chocolate ganache filling, ice pops, truffles, chocolate bars, energy bars, fudge pops, frosting, syrups and spreads, granola mixes, cake and pie fillings, ice cream and ganache.

A particular embodiment of the present invention is directed to an ice cream product formulation comprising raw organic cacao nibs, raw organic nut butter, raw organic dates, raw organic shredded coconut, raw organic dark agave nectar, raw organic sea salt and filtered water. All percentages are measured by volume of total volume of final product. For example, the present invention contemplates formulation for a dairy free ice cream of about total volume of final yield of 64 oz, comprising about 12% to about 15% raw organic cacao nibs, preferably from the South American cacao bean, about 17% to about 22% raw organic total nut butter (e.g., cashew or almond nut butter or a combination thereof), about 6% to about 9% raw organic dates, 0% to about 2% raw organic shreded coconut, about 12% to about 15% raw organic dark agave nectar, about 0.1% to about 0.3% raw organic sea salt and about 30% to about 40% filtered water.

By “organic” as used in “organic product,” “organic natural product” or “organic produce” is meant relating to, yielding, or involving the use of food produced (plants) or raised (animal) with the use of feed or fertilizer of plant or animal origin without employment of chemically formulated fertilizers, growth stimulants, antibiotics, pesticides or other chemicals which are toxic and/or harmful to the human body. All organic ingredients used in the present invention are in compliance with the National Organic Program (NOP) implemented by the United States Department of Agriculture (USDA).

By “raw” is meant being or nearly in natural state, e.g., without cooking or any other processing that may cause chemical or biochemical irreversible changes in the food or food ingredients. By “raw organic product” or “raw organic natural product” is meant any product made from an organic produce (or dairy product from an organic raised animal) in its natural state or without any processing that may cause significant chemical or biochemical change in the product, e.g., cooking at a high temperature. For example, by “raw organic cacao nibs” is meant that the live enzymes in the organic cacao nibs are preserved in their natural state, intact or biologically active. The raw ingredients used in the formulation of the present invention can be mechanically processed, e.g., by stirring or mixing; but such process should be carried out at a temperature not exceeding about 47° C. A temperature over 47° C. can destroy the live enzymes in organic produce. According to the present invention, the temperature in a homogenizer or blender for the mixing process should be controlled at about 0° C. to about 47° C., preferably, about 4° C. to about 45° C., more preferably, about 10° C. to about 15° C. Such control can be done by well-known technologies in the art. For example, a food grade thermometer can be used in the blending or mixing process to monitor the temperature levels in order to ensure the temperature of the mixture is not “heated” above 47° C. Alternatively and preferably, the mixing can be carried out in a temperature-controlled room (e.g., cold room, in which the temperature is about 0° C. to about 4° C.) or a homogenizer or blender with temperature controls, where the temperatures in the room or homogenizer can beset up at a level so that the during the mixing process, the temperature of the mixture will not exceed about 47° C., preferably, will not exceed 15° C. For example, in making the organic ice creams of the present invention, if the homogenizer with a temperature control is employed, the temperature can be pre-set to 4° C. so that the ice cream can be served fresh, cold and is rich with intact live enzymes.

According to the present invention, the nut butter, sweetening agent and flavor are all organic/natural products. Organic nut butter contains desired antioxidants but no undesired cholesterol, salt, or sugar. Nut butter also has low saturated fats. Thus, the nut butter used in the present invention is advantageous over butter from dairy products, which contain fat and cholesterol and are normally used in the conventional ice creams or dessert food products. The nut butter used in accordance with the present invention can be made from any organic nut or seed, including but not limited to, almond, cashew, macadamia nut, pumpkin seed, Brazil nut, hazelnut, pistachio nut, and sunflower seed. The preferred organic nut butter of the present invention is raw organic almond nut butter.

The amount of nut butter used in the formulation of the present invention depends on the final product to be made. Factors to be considered include, but are not limited to, taste (including the feel sensation of human body and texture of the product as well as true flavor of the product), consumer preference, and usage in the art. For example, in a formulation for making 32 oz mousse or about 555 grams of truffles or 64 oz regular texture ice cream, nut butter is used in an amount of about ½ to 5 tsp, preferably, about 3½ tsp; in a formulation for making 30 truffles, nut butter is optionally used in an amount of about ½ to 4 tsp, preferably, about 2 tsp. Other butters from organic produce, such as organic coconut butter or cacao butter, can also be used. For example, in a formulation for making 32 oz mousse, 64 oz regular texture ice cream), or 555 grams of truffles organic coconut butter is used in an amount of about ½ to 5 tsp, preferably, about 3 tsp; in a formulation for making 45 truffles 555 grams, organic coconut butter is used in an amount of about ½ to 5 tsp, preferably, about 3 tsp and cacao butter is used in an amount of about ¼ to 2 cup, preferably, about ¾ cup. According to the preference of consumers, dairy-free (vegan) or dairy ice creams can be made. In a formulation for making ice cream with dairy products, organic dairy products, preferably, organic heavy whipping cream can be used, in a amount about 1:1 ratio of cream to mixture of other ingredients. See Example 2.

According to the present invention, the organic sweetening agents contemplated are natural sweeteners from organic produces. By “sweetener” or “sweetening agent” is meant an ingredient or agent that gives the final product a sweet flavor (the flavor identical, similar or equivalent to that of sugar). Refined sugars (e.g., sucrose or fructose) are not natural products and are not employed in the present invention. A preferred sweetening agent of the present invention is raw organic light or amber agave nectar. The sweetener used in the present invention can be flexible depending on the products or market/consumer preference. For example, raw agave nectar and/or organic honey used in the present invention can be added at 0 to 10 tsb, preferably 8 tsb, in a formulation for making 32 oz mousse, 64 oz regular texture ice cream, or 45 truffles (about 555 grams).

Any organic chocolate product can be used in the present invention. Organic chocolates often have a richer and chocolate flavor relative to non-organic or industrial produced chocolate because of the way organic chocolates are grown. Cocoa plants grown in the shade of the rainforest—their natural habitat—where favorable nutrients and the lack of direct sunlight give the cocoa plant its best growing conditions. Accordingly, the preferred chocolate products of the present invention are raw organic cacao nibs or powders made from organic South American cacao bean, which tastes like dark chocolate but without undesired sugars. The amount of organic chocolate used in the present invention depends on the product to be made or market/consumer preference to the chocolate flavor and/or the taste, e.g., 0 to 2 cups in a formulation for making 32 oz mousse (preferably ¾ cup), 64 oz regular texture ice cream (preferably ¾ cup), or 45 truffles (555 grams) (preferably ½ cup).

Other additional flavors, such as raw organic sea salt, can also be added to the mixture. Salts can be used in limited amounts, which affect mix and finished-product qualities, such as handling properties and appearance of products. For example, in the present invention, not more than ¼ tsp of salt are use in a formulation for making 32 oz mousse or regular texture ice cream, or 45 (555) grams truffles.

Water and air are important constituents of ice cream and other snack food/desserts. Water can come from fluid ingredients, such as butter or honey, and/or from clean drinking water added to the mixture. The amount of water in each formulation depends on the volume and expected texture of the final product as well as the need to homogenize the mixture of ingredients. Water can also be employed in an identical or similar amount to which that is calculated for producing non-organic food products, e.g., traditional desserts or ice cream. For example, the amount of water added in a formulation for making 32 oz mousse or 64 oz regular texture ice cream, of the present invention can be 0 to 3 cups, preferably, 1½ cup. The amount of water added in a formulation for making 45 (555 grams) truffles of the present invention can be 0 to 1½ cups, preferably, 0 cups.

In a particular embodiment, the present invention is directed to a mousse formulation as illustrated in Example 1. In another particular embodiment, the present invention is directed to an ice cream formulation as illustrated in Example 2 or 3. In still another particular embodiment, the present invention is directed to a truffle formulation as illustrated in Example 4.

Another embodiment of the present invention is directed to a method of making food products, preferably, chocolate-based snack food and dessert products, more preferably, ice cream, comprising mixing nut butter, at least one sweetening agent, at least one flavor, water, and optionally at least one stabilizer. The mixture can be served fresh or frozen for storage. According the present invention, the nut butter, sweetening agent and flavor are raw organic natural products and the mixing process is conducted at a temperature not exceeding about 47° C.

The mixing process can be carried out by any practical means, e.g., by hand tools or any commercially available mixing machine, e.g., a Vita-Mix® whole food blending machine or a homogenizer.

According to the present invention, the mixing process should be carried out at a temperature not exceeding about 47° C. According to the present invention, the temperature in a homogenizer or blender for the mixing process should be controlled at about 0° C. to about 47° C., preferably, about 4° C. to about 45° C., more preferably, about 10° C. to about 15° C. Such temperature control can be conventionally achieved by known technologies in the art. For example, a food grade thermometer can be placed in the blending or mixing process, e.g., in a Vita-Mix® machine, to monitor the temperature levels in order to ensure the temperature of the mixture is not “heated” above 47° C. Alternatively and preferably, the mixture can be carried out in a temperature-controlled room (e.g., cold room, in which the temperature is about 0° C. to about 4° C.) or a homogenizer or blender with temperature controls, where the temperatures of the room or homogenizer can be set up at a level so that the during the mixing process, the temperature of the mixture will not exceed about 47° C., preferably, will not exceed about 15° C. For example, in making the organic ice creams of the present invention, if a homogenizer with temperature control is employed, the temperature can be set up at 4 C so that the ice cream can be served fresh, cold and rich with intact live enzymes. Alternatively, the products made in accordance with the present invention can be stored frozen, preferably, at a temperature between about −20° C. to about 0° C.

The present invention further contemplates a ready to mix or ready to serve organic snack food, dessert and/or ice cream package unit. By “package unit” is meant a discrete unit form, preferably; a unit form consistent with custom or trade standard in packaging a particular type of snack food, dessert or ice cream, e.g., 4 oz, 16 oz, 32 oz, 64 oz, pint or quart of ice cream containers or package unit), (measured by amount of total serving volume), plastic or glass containers in 4 oz or 8 oz unit (measured by amount of total serving volume) for mousse product of the present invention, or candy wrappers for truffles, which are wrapped either individually or in small batch. According to the present invention, a package unit comprises all the ingredients of the formulation of the present invention for making snack food, dessert or ice cream.

According to the present invention, the ingredients in a package unit can be mixed or separate. Each ingredient can be individually packaged in a package unit if desired. For example, for better chocolate flavor, the raw organic cacao nibs are preferably individually packaged in a package unit. Before serving, the raw organic cacao nibs are mixed with other ingredients and the final mixture is homogenized and freshly served or consumed. The package unit of the present invention is preferably refrigerated or frozen during storage. According to the present invention, the package unit of ready-to-mix or ready-to-serve snack food, dessert or ice creams provides the consumer a novel line of comestible products and an alternative means to produce consumer healthy food. For example a freshly homemade chocolate mousse from a chocolate mousse package unit of the present invention has the same taste or nutrient level as that freshly made in a store and has better flavor, mouth feel and more nutrients or living enzymes than industrial made ice creams.

The invention is further illustrated by the following specific examples that are not intended in any way to limit the scope of the invention.

### EXAMPLE 1

### Organic, Vegan and Raw Chocolaty Food

### Ingredients:

| Ingredient | Quantity | |
|---|---|---|
| Filtered Water | 1½ | cups |
| Raw, organic cacao nibs | ¾ | cup |
| Raw, organic almond butter or cashew butter | 3½ | tbs |
| Raw, organic agave nectar, light or raw, organic honey | 5 | tbs |
| Raw, organic dates or date paste | 4 | oz |
| Raw, organic coconut butter | 3 | tbs |
| Sea Salt | ¼ | tsp |
| Total Yield: 32 oz | | |

### Formulation:

Place all ingredients in a Vita-Mix® whole food blending machine in any order and blend for 3 minutes, stirring periodically. As a raw food product that is “enzymatically alive”, it is critical that temperatures during manufacturing do not exceed 118 degrees Fahrenheit. A food-grade thermometer should be used to test temperature levels in order to ensure the temperature of the mixture is not “heated” above 118 degrees so as to maintain the integrity of enzymatic activity.

Other flavor variations for the mousse can include, but are not limited to, dark chocolate chip, coconut, almond crunch, coffee, chili and spice, and fudge swirl. It is noted that additional spices or ingredients, such as cinnamon, chili, vanilla, nutmeg, almonds, cacao chips, and shredded coconut, do not alter the raw, organic state of final product.

### EXAMPLE 2

### This is Part of the “Disclosure” Organic Ice Cream, Includes Dairy

### Ingredients:

| Ingredient | Quantity | |
|---|---|---|
| Filtered Water | 1¾ | cups |
| Raw, organic cacao nibs | ¾ | cup |
| Raw, organic almond butter or cashew butter | 3½ | tbs |
| Raw, organic agave nectar, light or raw, organic honey | 10 | tbs |
| Raw, organic dates or date paste | 4 | oz |
| Raw, organic coconut butter | 3 | tbs |
| Raw, organic cacao powder | 3 | tbs |
| Sea Salt | ¾ | tsp |

| | |
|---|---|
| Organic Heavy Whipping Cream | 1:1 ratio of cream |
| | to mixture |
| Total Yield: 64 oz | |

Place all ingredients (except for the heavy whipping cream) in a Vita-Mix in any order and blend for 3 minutes, stirring periodically. As a raw food product that is “enzymatically alive,” it is critical that temperatures during manufacturing do not exceed 118 degrees Fahrenheit. A food grade thermometer must be used to test temperature levels in order to ensure the temperature of the mixture is not “heated” above 118 degrees so as to maintain the integrity of enzymatic activity. Add organic heavy whipping cream to the mixture and mix together in an ice cream maker. After ingredients are fully integrated, final mixture is placed in the freezer.

A commercial grade ice cream maker can optionally be used to incorporate ingredients and increase creaminess.

Other flavor variations for the organic ice cream can include, but are not limited to, dark chocolate chip, coconut, almond crunch, almond swirl, coffee, chili and spice, fudge swirl, dark chocolate chip mint, and chocolate chip strawberry. It is noted that additional spices or ingredients, such as cinnamon, chili, vanilla, nutmeg, almonds, cacao chips, and shredded coconut, do not alter the raw, organic state of final product.

### EXAMPLE 3

### Organic Ice Cream, Raw, Vegan (Dairy Free)

### Ingredients:

| Ingredient | Quantity | |
|---|---|---|
| Filtered Water | 1½ | cups |
| Raw, organic cacao nibs | ¾ | cup |
| Raw, organic almond butter or cashew butter | 3 | tbs |
| Raw, organic agave nectar, light or amber | 6 | tbs |
| Raw, organic dates or date paste | 4 | oz |
| Raw, organic coconut butter | 1½ | tbs |
| Sea Salt | ¼ | tsp |
| Ingredients for Nut Milk: | 1:1 ratio | |
| | to mixture | |
| Filtered Water | 1½ | cups |
| Raw, organic cashews | 1¼ | cups |
| Raw, organic coconut butter | 1 | tbs |
| Raw, organic agave nectar | 10 | tbs |
| Raw, organic cacao powder3 tbs | | |
| Sea Salt | ½ | tsp |
| Total Yield: 64 oz | | |

1. Make nut milk first and set aside.

2. Place all remaining ingredients into a Vita-Mix® whole food blending machine in any order and blend for 3 minutes, stirring periodically. As a raw food product that is “enzymatically alive”, it is critical that temperatures during manufacturing do not exceed 118 degrees Fahrenheit. A food grade thermometer must be used to test temperature levels in order to ensure the temperature of the mixture is not “heated” above 118 degrees so as to maintain the integrity of enzymatic activity.

3. Blend nut milk from Step 1 with the mixture produced in Step 2 in an ice cream maker.

4. After ingredients are fully integrated, final mixture is placed in the freezer.

Other flavor variations for the raw dairy free organic ice cream can include, but are not limited to, dark chocolate chip, coconut, almond crunch, almond swirl, coffee, chili and spice, fudge swirl, dark chocolate chip mint, and chocolate chip strawberry. It is noted that additional spices or ingredients, such as cinnamon, chili, vanilla, nutmeg, almonds, cacao chips, and shredded coconut, do not alter the raw, organic state of final product.

### EXAMPLE 4

### Raw Vegan Organic Truffles

### Ingredients:

| | |
|---|---|
| Ingredient | Quantity |

| | | |
|---|---|---|
| Raw, organic cacao powder | .23 | cups |
| | (1.875 | oz) |
| Raw, organic agave nectar, light or amber | 13.125 | tbs |
| | (6.5625 | oz) |
| Raw, organic date paste | (3.75 | oz) |
| Raw, organic coconut butter | 2.25 | tbs |
| | (1.125 | oz) |
| Sea Salt | .618 | tsp |
| | (.103 | oz) |
| Cacao butter, grated | .508 | cup |
| | (4.0625 | oz) |
| Coating ingredient of choice (cacao powder, | 4 | oz |
| shredded coconut, crushed almonds, etc.) | | |
| Total Yield: 20 oz 45 truffles (approx 555 grams) | | |

1. Slicing or grating ¾ cup solid cacao butter and melting in a kettle or pot or dehydrator at no higher than 118 degrees Fahrenheit, periodically using candy thermometer to ensure temperature does not exceed 118 degrees.

2. While cacao butter is melting down, place dates, agave, and salt into Cuisinart Food Processor, a commercial mixer or kettle with robot coupe mixer and blend until smooth.

10 3. Then added melted cacao butter and coconut butter into Cuisinart Food

Processor a commercial mixer or kettle with robot coupe mixer until smooth. Add ½ cup cacao powder and continue to mix on high speed until fully integrated.

4. Once mixture of Step 3 is fully integrated, refrigerate the mixture until solidified (approximately 4 hours). When solidified, roll mixture into 1 inch balls and then roll balls into coating of choice (e.g., cacao powder, shredded coconut, or crushed almonds). Refrigerate for at least four hours.

Other flavor variations for the truffles can include, but are not limited to, dark chocolate chip, coconut, almond crunch, coffee, chili and spice, fudge, raspberry, vanilla, and chocolate peppermint. It is noted that additional spices or ingredients, such as cinnamon, chili, vanilla, nutmeg, almonds, cacao chips, and shredded coconut, do not alter the raw, organic state of final product.

What is claimed is:

1. A truffle composition comprising an ingredient mixture of about 35% to 45% raw agave nectar, about 20% to 25% raw cacao butter, about 15% to 25% raw dates, at least one raw organic flavor in an amount of about 5% to 15%, at least one raw organic coconut butter in amount of about 1% to about 10%, wherein the percentages are measured by volume relative to that of the total volume of the final mixture and wherein the ingredients are mixed in a homogenizer or blender at a temperature not exceeding about 118° F.

2. A mousse dessert composition comprising a mixture of about 20% to about 25% in volume of a raw organic flavoring agent, about 4% to about 5% in volume of raw organic nut butter, about 15% to about 18% in volume of raw organic dates, 0% to about 1% in volume of raw organic shredded coconut, about 8% to about 10% in volume of raw organic dark agave nectar, about 1% to about 3% in volume raw organic sea salt and about 40% to about 45% in volume of filtered water.

3. The composition of claim 2 wherein the nut butter is made from organic nuts or organic seeds selected from the group consisting of almonds, cashews, macadamia nuts, pumpkin seeds, Brazil nuts, hazelnuts, pistachio nuts, and sunflower seeds.

4. The composition of claim 2, wherein the raw organic flavoring agent is organic cacao nibs and/or organic sea salts.

5. The composition of claim 4, wherein the organic cacao nibs are South American organic cacao nibs.

6. A method of producing a dessert food product comprising:
a) forming the mixture of claim 2
b) mixing the mixture from a), and
c) optionally, freezing the mixed product from b),
wherein the nut butter, sweetening agent and flavor are raw organic natural products and wherein the mixing step is carried out at a temperature not exceeding about 118° F.

7. The method of claim 6, wherein the mixing is carried out in a Vita-Mix® food homogenizer at room temperature for about three minutes, stirring periodically.

8. The method of claim 6, wherein the nut butter is made from organic nut or organic seed selected from the group consisting of almond, cashew, macadamia nut, pumpkin seed, Brazil nut, hazelnut, pistachio nut, and sunflower seed.

9. The method of claim 6, wherein the organic flavor is organic cacao nibs and/or organic sea salts.

10. The method of claim 9, wherein the organic cacao nibs are South American organic cacao nibs.

11. A dessert food package unit comprising the composition of any of claims 1-2.

12. The package unit of claim 11, wherein the ingredients are individually packed in the package unit.

13. A method of producing a dessert food product comprising:
a) forming the mixture of claim 1
b) mixing the mixture from a), and
c) optionally, freezing the mixed product from b),
wherein wherein the cacao butter, sweetening agent and flavor are raw organic natural products and wherein the mixing step is carried out at a temperature not exceeding about 118° F.
